(19) United States
(12) Patent Application Publication
(10) Pub. No.: US 2022/0229959 A1
(43) Pub. Date: Jul. 21, 2022

(54) INJECTION-PRODUCTION RELATIONSHIP OPTIMIZATION METHOD BASED ON HETEROGENEOUS FLOW FIELD CHARACTERIZATION

(71) Applicant: China University Of Petroleum (East China), Dongying City (CN)

(72) Inventors: Kai Zhang, Dongying City (CN); Ji Qi, Dongying City (CN); Jun Yao, Dongying City (CN); Wei Wang, Dongying City (CN); Guoxin Li, Dongying City (CN); Liming Zhang, Dongying City (CN); Piyang Liu, Dongying City (CN); Chuanjin Yao, Dongying City (CN); Junrong Liu, Dongying City (CN); Qingqing Jiao, Dongying City (CN); Shujing Liu, Dongying City (CN); Wensheng Zhou, Dongying City (CN)

(21) Appl. No.: 17/540,841

(22) Filed: Dec. 2, 2021

(30) Foreign Application Priority Data
Jan. 20, 2021 (CN) 202110085022.2

(51) Int. Cl. G06F 30/28

(52) U.S. Cl. CPC G06F 30/28

(57) ABSTRACT

The present invention relates to an injection-production relationship optimization method based on heterogeneous flow field characterization. The method comprises the steps of: first, calculating a density of a flow field by adopting a method of converting a linear density into a dot density; then, calculating an intensity of the flow field by adopting an analytic hierarchy process; and performing flow field characterization by utilizing mathematical methods such as PCA dimensionality reduction and clustering and calculating a product of flow line densities and intensities of flow fields in different regions of the flow field, and performing optimization for a goal of minimizing a variance of the product in combination of an genetic algorithm to solve the optimum injection-production quantity as an optimum solution (the optimum injection-production quantity) that enables the flow field to be displaced in a balanced manner. Compared with the prior art, the present invention has the following beneficial effects: the flow line linear density is converted into point density in a relatively small error range via an oil field flow line density calculating method; the method is better adaptive to all the flow fields of the oil fields and may reflect characteristics of all aspects of the flow field; characteristics of the flow field are characterized perfectly by adopting dimensionality reduction and clustering method, thereby visualizing characterization of the flow field; and the injection and production amount of the flow field is distributed again by means of the genetic algorithm, and a preferred flow field development scheme is formulated.

### FIELD OF THE INVENTION

The present invention belongs to the field of oil and gas field development, in particular to an injection-production relationship optimization method based on heterogeneous flow field characterization.

### BACKGROUND OF THE INVENTION

With development of the oil field development technique, flow field information becomes to be a key point concerned by oil deposit development workers. How to adjust an oil field development scheme by using existing flow field data becomes an important issue on oil field.

The flow field may be construed as change of states of several fluid particles in a field. The flow line is macroscopic reflection of fluid movement. The current flow line generating algorithms in each field have tended to reach perfection. However, the generated flow lines are tedious in distribution and inconsistent in quality of the produced flow line. In the field of oil field, it is hard to utilize the generated flow line fields effectively. It is in particular important for post-processing of the flow line.

At present, most oil fields in China have entered the middle and later periods of development. The water content is raised and the development benefit is decreased. The flow field as direct reflection of an oil deposit fluid has important meaning in guiding later development of the oil field. Flow field characterization means description of the flow field, and the flow field information is expressed intuitively. Attention to the flow field in the oil and gas deposit development process facilitates oil field system adjustment, abstract and complex flow field data is converted into images understood easily, and precise visualization of the flow field of the oil field is a development direction characterizing future flow field. By means of a flow field characterization method, optimization and adjustment on an oil field development scheme is an important objective in oil field development.

### SUMMARY OF THE INVENTION

Flow lines generated by a flow line numerical value simulator are tedious in distribution and are hardly utilized and described effectively. In order to solve the problem, related data of generating the flow lines is extracted, the flow line density and the flow field intensity are calculated, a comprehensive characterization system is established for the flow field based on the obtained flow line density and flow field intensity, and the flow field is optimized to realize a balanced displacing effect of the flow field. The present invention provides an injection-production relationship optimization method based on heterogeneous flow field characterization for characterization of a flow field of an oil field and optimization and adjustment of a development scheme.

In order to solve the problem, the present invention adopts a technical solution of: first, calculating a density of a flow field by adopting a method of converting a linear density into a dot density; then, calculating an intensity of the flow field by adopting an analytic hierarchy process; and performing flow field characterization by utilizing mathematical methods such as PCA dimensionality reduction and clustering and calculating a product of flow line densities and intensities of flow fields in different regions of the flow field, and performing optimization for a goal of minimizing a variance of the product in combination of an genetic algorithm to solve the optimum injection-production quantity as an optimum solution (the optimum injection-production quantity) that enables the flow field to be displaced in a balanced manner.

Compared with the prior art, the present invention has the following beneficial effects:

1. The flow line linear density is converted into point density in a relatively small error range via an oil field flow line density calculating method, and the method may extend to other fields;

2. Based on a flow line numerical value simulating result, the flow line density and the flow field intensity are calculated, a novel flow field comprehensive characterization method is provided by means of a scientific means by following a scientific law, and the method is better adaptive to all the flow fields of the oil fields and may reflect characteristics of all aspects of the flow field;

3. In order to solve the problems of tedious flow lines and low visualization degree of the oil deposit numerical value simulator, characteristics of the flow field are characterized perfectly by adopting dimensionality reduction and clustering method in combination with the calculated flow field density and flow field intensity, thereby visualizing characterization of the flow field; and

4. On the premise of establishing characterization of the flow field, the injection and production amount of the flow field is distributed again by means of the genetic algorithm, and a preferred flow field development scheme is formulated.

### BRIEF DESCRIPTION OF THE FIGURES

FIG. 1 is a flow diagram of an injection-production relationship optimization method based on heterogeneous flow field characterization;

FIG. 2 is a genetic algorithm principle diagram;

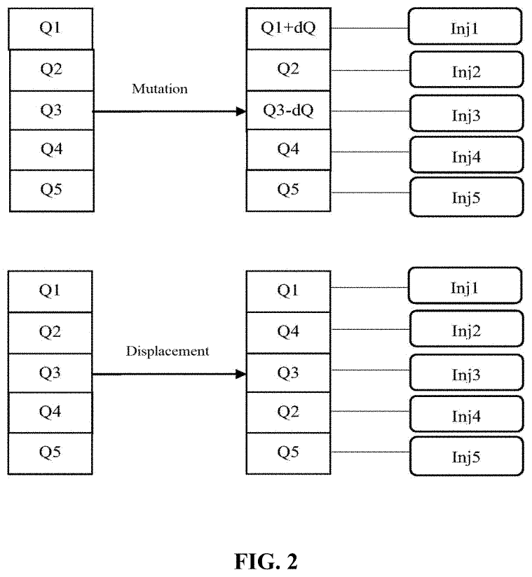

FIG. 3A is a visualized schematic diagram of flow field intensity of each region of the flow field;

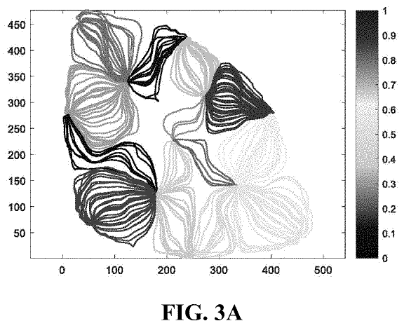

FIG. 3B is a visualized schematic diagram of flow field intensity and density of each region of the flow field.

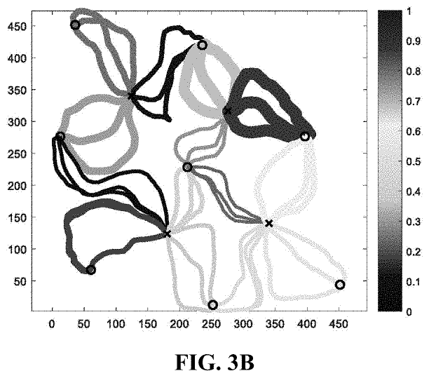

### DESCRIPTION OF THE INVENTION

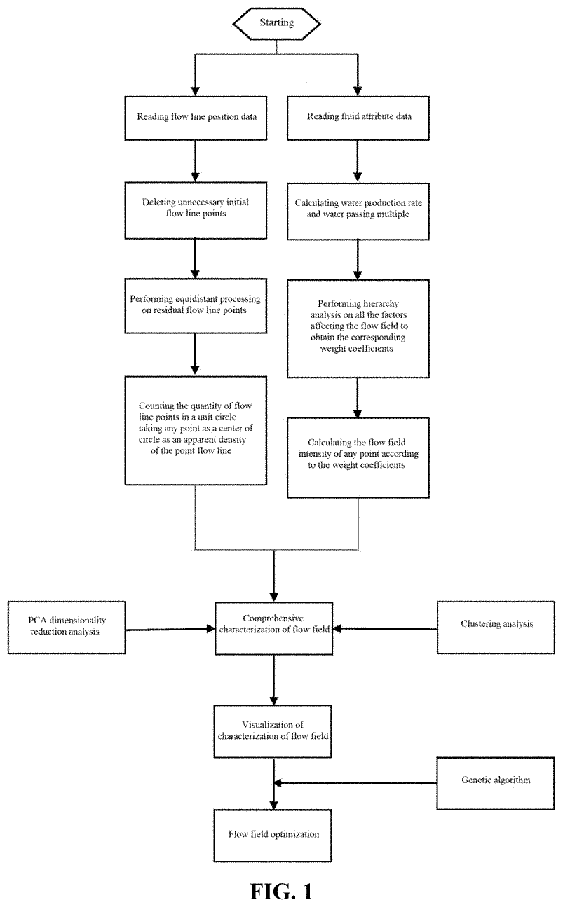

As shown in FIG. 1, an injection-production relationship optimization method based on heterogeneous flow field characterization comprises the specific steps of:

Step 1, acquiring position data of each of flow lines in the flow field, and calculating a flow line density of any point in the flow field, comprising the specific steps of:

Step 1.1, analyzing current all flow line points that form the flow line, and deleting all repeated points generated by a flow line generating algorithm;

Step 1.2, screening residual flow line points, analyzing distances between all the adjacent flow line points that form the flow line, improving a calculating efficiency, and deleting a next point, with a relatively small distance therebetween, that does not affect a shape of the flow line;

Step 1.3, selecting the smallest distance between adjacent flow line points that are processed hereon, marking the distance as Dmin, giving a calculating accuracy N, and taking Dmin/N is taken as “an equal distance”; for the flow line processed in Step 1.1 and Step 1.2, from a starting point 0 of the flow line, marking two adjacent points as Ai and Bi, marking a connecting line between Ai and Bi as a basis vector [symbol] by taking Dmin/N) [symbol] as “an equidistant distance”, obtaining a coordinate Pn=Ai+(Dmin/N)/| [symbol] of the next point according to a coordinate of the previous point and an equidistant vector, thereby adding several equidistant points between Ai and Bi from Ai, performing calculating till the calculated points exceeds a point B, starting to calculating a next flow line point Ai+1 till the whole flow line is calculated completely, wherein any two adjacent flow line points added according to the algorithm (except a distance from Bi to the previous point of Bi) is equidistant and the shape of an original flow line is not damaged; and

Step 1.4, performing K_means clustering analysis on a point set generated in Step 1.3, marking N clustering centers generated in K_means clustering as a point set Pdata, and counting a number Σnum(Pdata) of points in the point set Pdata in a same radial circle (ball) for any one point in the flow field as an apparent density of the current point, wherein a radius R of the ball or circle is given according to the field of the flow field and the apparent density of the flow line.

Step 2, calculating an intensity of a flow field of each point in the flow field according to an analytic hierarchy process combined with an empirical formula, comprising the specific steps of:

Step 2.1, reading a static geological data porosity φ, a permeability k, a formation fluid dynamic data saturability Sw, a fluid velocity V and fluid PVT data, comprising an oil-water phase permeating table, an oil-water viscosity μoμw and an irreducible water saturation Swf in a flow field data file generated by an oil deposit flow line numerical value simulator;

Step 2.2, performing primary phase permeating fitting as needed according to the phase permeating table to obtain a phase permeating function f(Sw);

Step 2.3, obtaining a water production rate of each of flow line points in combination with the fluid phase permeating function and the fluid viscosity according to a following formula; and

F_{w}=1/(1+μ_{w}*e^{f(S}^{_{w}}⁾/μₒ)

calculating a water passing multiple of each of points on the flow line by the water production rate,

$$\vert \frac{1}{\frac{{F}_{w ( {s}_{wf} )} * {a}^{*} {μ}_{w} * {e}^{f ( {s}_{wf} )}}{{μ}_{0}}} - \frac{1}{\frac{{F}_{w ( {s}_{w} )} * {a}^{*} {μ}_{w} * {e}^{f ( {s}_{w} )}}{{μ}_{0}}} - {S}_{w} + {S}_{wf} \vert ,$$

where in a is a primary item coefficient of phase permeating fitting;

Step 2.4, standardizing all original data and solved data according to a following formula

$$data = \frac{data - {data}_{min}}{{data}_{max} - {data}_{min}} ,$$

comprising porosity φ, permeability K, water production rate F_{w}, water passing multiple Q_{w} and fluid velocity V of each of points of the flow field;

performing graded evolution on the porosity, permeability, water production rate, water passing multiple and fluid velocity from 1 to 9 in combination with production historical information, wherein the larger the important degree in affecting the flow field is, the higher the scalar value of the factor is;

Step 2.5, establishing a hierarchy analytical judging matrix according to grading in Step 2.4 for hierarchy analysis, comprising the specific steps of:

constructing a hierarchy judging matrix as shown in a table 2 according to a uniform matrix method;

solving a characteristic vector W of the maximum characteristic root λₘₐₓ of the judging matrix, wherein an element of the vector after normalization is weight sequencing of relative importance of some factor in the upper layer by the element in the same hierarchy; and

checking consistency, calculating a consistency index

$$CI = \frac{{λ}_{max} - n}{n - 1}$$

is calculated, wherein n is a number of factors; calculating a consistency ratio

$$CR = \frac{CI}{RI} ,$$

wherein if CR is smaller than 0.1, taking a vector corresponding to the normalized maximum characteristic root as a weight vector, and obtaining weight coefficients of each factor: a₁, a₂, b₁, b₂ and b₃ according to the weight vector; if CR is greater than 0.1, returning to Step 2.4, performing graded evaluation again to construct a novel hierarchy judging matrix; and calculating a comprehensive flow field intensity E=a₁*K+a₂*φ+b₁*Fw+b₂*Q_{w}+b₃*V of any point.

TABLE 1
Random Consistency Index RI

| n | 1 | 2 | 3 | 4 | 5 | 6 | 7 | 8 | 9 | 10 |
|---|---|---|---|---|---|---|---|---|---|---|
| RI | 0 | 0 | 0.58 | 0.90 | 1.12 | 1.24 | 1.32 | 1.41 | 1.45 | 1.49 |

TABLE 2
Judging Matrix

| | Factor 1 | Factor 2 | Factor 3 |
|---|---|---|---|
| Factor 1 | 1 | 2 | 3 |
| Factor 2 | ½ | 1 | 3/2 |
| Factor 3 | ⅓ | ⅔ | 1 |

Step 3, combining PCA dimensionality reduction and clustering analysis to characterize and visualize the flow field, comprising the specific steps of:

Step 3.1, grouping all the flow lines according to different water injection wells and producing wells, each of flow lines characterizing a flow field dynamic state between any two wells, each group of flow lines being marked as Gᵢⱼ={l₁, l₂ . . . lₘ}, wherein lₘ represents any one flow line between the water injection well i and the producing well j, and i and j represent numbers of the water injection well and the producing well;

Step 3.2, extracting characteristics of each group of flow lines: there are N flow line points on one flow line, each of flow line points comprises 3*N position characteristics, N saturability characteristics and N velocity characteristics, i.e., one flow line has 5*N attribute dimensionalities, wherein in considering a problem that the attribute dimensionality of each of flow lines is inconsistent as the number of the flow line points on the flow line is inconsistent, based on the flow line with the maximum flow lint point quantity, the flow line points of the flow line with relatively small flow lint point quantity are increased, the increased flow line points are consistent with the last flow line point of the flow line, for example, lₘ is equal to {p₁, p₂, p₃, . . . pₙ₋₂, pₙ₋₁, pₙ₋₁,}, the processed flow line point quantity is turned from N−1 to N, and each flow line in the group of flow lines has 5*N attribute dimensionalities;

Step 3.3, performing PCA dimensionality reduction on each group of flow lines, wherein each of flow lines may be decreased from 5*N attribute dimensionalities to M attribute dimensionalities, and selecting a primary component to perform K_means clustering analysis according to dimensionality reduction result and selecting several clustering centers as a main flow line of each of flow lines by taking a clustering result of each of flow lines as reference; and

Step 3.4, calculating an average flow field intensity

$$\overline{E} = \frac{{\sum }_{1}^{M} {\sum }_{1}^{N} E}{M * N} ,$$

and an average flow line density

$$\overline{D} = \frac{{\sum }_{1}^{M} {\sum }_{1}^{N} D}{M * N} ,$$

of each of flow lines, wherein M is a total number of flow lines in the group of flow lines and N is a number of the flow line points on each of flow lines; and

Step 3.4, simplifying the flow field is simplified, wherein a color of the main flow line represents an average flow field intensity reflecting influence of a historical flow field, coarseness of the main flow line represents an average flow line density of a current flow field region reflecting an instantaneous characteristic of the flow field, thereby realizing visualized characterization of the flow field;

Step 4, optimizing the flow field for a goal of balanced displacement of water control and oil increase in combination of a genetic algorithm, comprising the specific steps of:

Step 4.1, defining a uniformity coefficient of the flow field: defining a displacement capacity of a region between well pairs of each of flow fields as Rᵢⱼ=Ē*D̅, where Ē represents an average flow field intensity between the well pairs, D̅ represents an average flow line density between the well pairs, the flow field intensity reflects a historical displacement capacity and the flow line density reflects a current flow field displacement capacity; and defining the flow field displacing uniformity coefficient as U=Var(Rᵢⱼ);

Step 4.2, simulating a flow line numerical value on an initial injection and production amount, and calculating the flow field displacing uniformity coefficient U according to the average flow line intensity and the average flow line density between the flow lines according to Step 1 and Step 2; and

Step 4.3, adopting an improved genetic algorithm to ensure unchanged total injection and production amount to simulate displacement and mutation operations of the nature, wherein an optimized objective function is the minimum flow field displacement nonuniformity coefficient U, and generating a more preferred injection and production scheme by means of an optimization algorithm.

The above steps are summarized as follows: the method comprises the steps of: first, calculating a density of a flow field by adopting a method of converting a linear density into a dot density; then, calculating an intensity of the flow field by adopting an analytic hierarchy process; and performing flow field characterization by utilizing mathematical methods such as PCA dimensionality reduction and clustering and calculating a product of flow line densities and intensities of flow fields in different regions of the flow field, and performing optimization for a goal of minimizing a variance of the product in combination of an genetic algorithm to solve the optimum injection-production quantity as an optimum solution (the optimum injection-production quantity) that enables the flow field to be displaced in a balanced manner.

1. An injection-production relationship optimization method based on heterogeneous flow field characterization, comprising the specific steps of:
Step 1, acquiring position data of each of flow lines in the flow field and calculating a flow line density of any point in the flow field;
Step 2, calculating an intensity of a flow field of each point in the flow field according to an analytic hierarchy process combined with an empirical formula;
Step 3, combining PCA dimensionality reduction and clustering analysis to characterize and visualize the flow field; and
Step 4, optimizing the flow field for a goal of balanced displacement of water control and oil increase in combination of a genetic algorithm.

2. The injection-production relationship optimization method based on heterogeneous flow field characterization according to claim 1, characterized in that Step 1 comprises the specific steps of:
Step 1.1, analyzing current all flow line points that form the flow line and deleting all repeated points generated by a flow line generating algorithm;
Step 1.2, screening residual flow line points, analyzing distances between all the adjacent flow line points that form the flow line, improving a calculating efficiency and deleting a next point, with a relatively small distance there between, that does not affect a shape of the flow line;
Step 1.3, selecting the smallest distance between adjacent flow line points that are processed hereon, marking the distance as Dₘᵢₙ, giving a calculating accuracy N, and taking Dₘᵢₙ/N as “an equal distance”; for the flow line processed in Step 1.1 and Step 1.2, from a starting point 0 of the flow line, marking two adjacent points as Aᵢ and Bᵢ, marking a connecting line between Aᵢ and Bᵢ as a basis vector [symbol] by taking Dₘᵢₙ/N) [symbol] [symbol] as “an equidistant distance”, obtaining a coordinate Pₙ=Aᵢ+(Dₘᵢₙ/N) [symbol] [symbol] of the next point according to a coordinate of the previous point and an equidistant vector, thereby adding several equidistant points between Aᵢ and Bi from Aᵢ, performing calculating till the calculated points exceeds a point B, starting to calculating a next flow line point Aᵢ₊₁ till the whole flow line is calculated completely, wherein any two adjacent flow line points added according to the algorithm (except a distance from Bᵢ to the previous point of Bᵢ) is equidistant and the shape of an original flow line is not damaged; and
Step 1.4, performing K_means clustering analysis on a point set generated in Step 1.3, marking N clustering centers generated in K_means clustering as a point set P_{data}, and counting a number Σnum(P_{data}) of points in the point set P_{data} in a same radial circle (ball) for any one point in the flow field as an apparent density of the current point, wherein a radius R of the ball or circle is given according to the field of the flow field and the apparent density of the flow line.

3. The injection-production relationship optimization method based on heterogeneous flow field characterization according to claim 1, characterized in that Step 2 comprises the specific steps of:
Step 2.1, reading a static geological data porosity φ, a permeability K, A formation fluid dynamic data saturability S_{w}, a fluid velocity V and fluid PVT data, comprising an oil-water phase permeating table, an oil-water viscosity μₒμ_{w} and an irreducible water saturation S_{wf} in a flow field data file generated by an oil deposit flow line numerical value simulator;
Step 2.2, performing primary phase permeating fitting as needed according to the phase permeating table to obtain a phase permeating function f(S_{w});
Step 2.3, obtaining a water production rate of each of flow line points in combination with the fluid phase permeating function and the fluid viscosity according to a following formula; and
F_{w}=1/(1+μ_{w}*e^{f(S}^{_{w}}⁾/μₒ);
calculating a water passing multiple of each of points on the flow line by the water production rate,
$$\vert \frac{1}{\frac{{F}_{w ( {s}_{w f} )} * {a}^{*} {μ}_{w} * {e}^{f ( {s}_{w f} )}}{{μ}_{0}}} - \frac{1}{\frac{{F}_{w ( {s}_{w} )} * {a}^{*} {μ}_{w} * {e}^{f ( {s}_{w} )}}{{μ}_{0}}} - {S}_{w} + {S}_{w f} 1 ,$$
wherein a is a primary item coefficient of phase permeating fitting;
Step 2.4, standardizing all original data and solved data according to a following formula
$$data = \frac{data - {data}_{min}}{{data}_{max} - {data}_{min}} ,$$
comprising porosity φ, permeability K, water production rate F_{w}, water passing multiple Q_{w} and fluid velocity V of each of points of the flow field;
performing graded evolution on the porosity, permeability, water production rate, water passing multiple and fluid velocity from 1 to 9 in combination with production historical information, wherein the larger the important degree in affecting the flow field is, the higher the scalar value of the factor is;
Step 2.5, establishing a hierarchy analytical judging matrix according to grading in Step 2.4 for hierarchy analysis, comprising the specific steps of:
constructing a hierarchy judging matrix as shown in a table 2 according to a uniform matrix method;
solving a characteristic vector W of the maximum characteristic root λₘₐₓ of the judging matrix, wherein an element of the vector after normalization is weight sequencing of relative importance of some factor in the upper layer by the element in the same hierarchy; and
checking consistency, calculating a consistency index
$$CI = \frac{{λ}_{max} - n}{n - 1} ,$$
wherein n is a number of factors; calculating a consistency ratio
$$C R = \frac{CI}{RI} ,$$
wherein if CR is smaller than 0.1, taking a vector corresponding to the normalized maximum characteristic root as a weight vector, and obtaining weight coefficients of each factor: a₁, a₂, b₁, b₂ and b₃ according to the weight vector; if CR is greater than 0.1, returning to Step 2.4, performing graded evaluation again to construct a novel hierarchy judging matrix; and calculating a comprehensive flow field intensity E=a₁*K+a₂*φ+b₁*Fw+b₂*Q_{w}+b₃*V of any point.

4. The injection-production relationship optimization method based on heterogeneous flow field characterization according to claim 1, characterized in that Step 3 comprises the specific steps of:
Step 3.1, grouping all the flow lines according to different water injection wells and producing wells, each of flow lines characterizing a flow field dynamic state between any two wells, each group of flow lines being marked as Gᵢⱼ={l₁, l₂ . . . lₘ}, wherein lₘ represents any one flow line between the water injection well i and the producing well j, and i and j represent numbers of the water injection well and the producing well;
Step 3.2, extracting characteristics of each group of flow lines: there are N flow line points on one flow line, each of flow line points comprises 3*N position characteristics, N saturability characteristics and N velocity characteristics, i.e., one flow line has 5*N attribute dimensionalities, wherein in considering a problem that the attribute dimensionality of each of flow lines is inconsistent as the number of the flow line points on the flow line is inconsistent, based on the flow line with the maximum flow lint point quantity, the flow line points of the flow line with relatively small flow lint point quantity are increased, the increased flow line points are consistent with the last flow line point of the flow line, for example, lₘ is equal to {p₁, p₂, p₃, . . . , pₙ₋₂, pₙ₋₁, pₙ₋₁,}, the processed flow line point quantity is turned from N−1 to N, and each flow line in the group of flow lines has 5*N attribute dimensionalities;
Step 3.3, performing PCA dimensionality reduction on each group of flow lines, wherein each of flow lines may be decreased from 5*N attribute dimensionalities to M attribute dimensionalities, and selecting a primary component to perform K_means clustering analysis according to dimensionality reduction result and selecting several clustering centers as a main flow line of each of flow lines by taking a clustering result of each of flow lines as reference; and
Step 3.4, calculating an average flow field intensity
$$\overline{E} = \frac{{\sum }_{1}^{M} {\sum }_{1}^{N} E}{M * N} ,$$
and an average flow line density
$$\overline{D} = \frac{{\sum }_{1}^{M} {\sum }_{1}^{N} D}{M * N} ,$$
of each of flow lines, wherein M is a total number of flow lines in the group of flow lines and N is a number of the flow line points on each of flow lines; and
Step 3.4, simplifying the flow field, wherein a color of the main flow line represents an average flow field intensity reflecting influence of a historical flow field, coarseness of the main flow line represents an average flow line density of a current flow field region reflecting an instantaneous characteristic of the flow field, thereby realizing visualized characterization of the flow field.

5. The injection-production relationship optimization method based on heterogeneous flow field characterization according to claim 1, characterized in that Step 4 comprises the specific steps of:
Step 4.1, defining a uniformity coefficient of the flow field: defining a displacement capacity of a region between well pairs of each of flow fields as Rᵢⱼ=Ē*D̅, wherein Ē represents an average flow field intensity between the well pairs, D̅ represents an average flow line density between the well pairs, the flow field intensity reflects a historical displacement capacity and the flow line density reflects a current flow field displacement capacity; and defining the flow field displacing uniformity coefficient as U=Var(Rᵢⱼ);
Step 4.2, simulating a flow line numerical value on an initial injection and production amount, and calculating the flow field displacing uniformity coefficient U according to the average flow line intensity and the average flow line density between the flow lines according to Step 1 and Step 2; and
Step 4.3, adopting an improved genetic algorithm to ensure unchanged total injection and production amount to simulate displacement and mutation operations of the nature, wherein an optimized objective function is the minimum flow field displacement nonuniformity coefficient U, and generating a more preferred injection and production scheme by means of an optimization algorithm.

6. The injection-production relationship optimization method based on heterogeneous flow field characterization according to claim 2, characterized in that Step 3 comprises the specific steps of:
Step 3.1, grouping all the flow lines according to different water injection wells and producing wells, each of flow lines characterizing a flow field dynamic state between any two wells, each group of flow lines being marked as Gᵢⱼ={l₁, l₂ . . . lₘ}, wherein lₘ represents any one flow line between the water injection well i and the producing well j, and i and j represent numbers of the water injection well and the producing well;
Step 3.2, extracting characteristics of each group of flow lines: there are N flow line points on one flow line, each of flow line points comprises 3*N position characteristics, N saturability characteristics and N velocity characteristics, i.e., one flow line has 5*N attribute dimensionalities, wherein in considering a problem that the attribute dimensionality of each of flow lines is inconsistent as the number of the flow line points on the flow line is inconsistent, based on the flow line with the maximum flow lint point quantity, the flow line points of the flow line with relatively small flow lint point quantity are increased, the increased flow line points are consistent with the last flow line point of the flow line, for example, lₘ is equal to {p₁, p₂, p₃, . . . , pₙ₋₂, pₙ₋₁, pₙ₋₁,}, the processed flow line point quantity is turned from N−1 to N, and each flow line in the group of flow lines has 5*N attribute dimensionalities;
Step 3.3, performing PCA dimensionality reduction on each group of flow lines, wherein each of flow lines may be decreased from 5*N attribute dimensionalities to M attribute dimensionalities, and selecting a primary component to perform K_means clustering analysis according to dimensionality reduction result and selecting several clustering centers as a main flow line of each of flow lines by taking a clustering result of each of flow lines as reference; and
Step 3.4, calculating an average flow field intensity
$$\overline{E} = \frac{{\sum }_{1}^{M} {\sum }_{1}^{N} E}{M * N} ,$$
and an average flow line density
$$\overline{D} = \frac{{\sum }_{1}^{M} {\sum }_{1}^{N} D}{M * N} ,$$
of each of flow lines, wherein M is a total number of flow lines in the group of flow lines and N is a number of the flow line points on each of flow lines; and
Step 3.4, simplifying the flow field, wherein a color of the main flow line represents an average flow field intensity reflecting influence of a historical flow field, coarseness of the main flow line represents an average flow line density of a current flow field region reflecting an instantaneous characteristic of the flow field, thereby realizing visualized characterization of the flow field.

7. The injection-production relationship optimization method based on heterogeneous flow field characterization according to claim 3, characterized in that Step 3 comprises the specific steps of:
Step 3.1, grouping all the flow lines according to different water injection wells and producing wells, each of flow lines characterizing a flow field dynamic state between any two wells, each group of flow lines being marked as Gᵢⱼ={l₁, l₂ . . . lₘ}, wherein lₘ represents any one flow line between the water injection well i and the producing well j, and i and j represent numbers of the water injection well and the producing well;
Step 3.2, extracting characteristics of each group of flow lines: there are N flow line points on one flow line, each of flow line points comprises 3*N position characteristics, N saturability characteristics and N velocity characteristics, i.e., one flow line has 5*N attribute dimensionalities, wherein in considering a problem that the attribute dimensionality of each of flow lines is inconsistent as the number of the flow line points on the flow line is inconsistent, based on the flow line with the maximum flow lint point quantity, the flow line points of the flow line with relatively small flow lint point quantity are increased, the increased flow line points are consistent with the last flow line point of the flow line, for example, lₘ is equal to {p₁, p₂, p₃, . . . , pₙ₋₂, pₙ₋₁, pₙ₋₁,}, the processed flow line point quantity is turned from N−1 to N, and each flow line in the group of flow lines has 5*N attribute dimensionalities;
Step 3.3, performing PCA dimensionality reduction on each group of flow lines, wherein each of flow lines may be decreased from 5*N attribute dimensionalities to M attribute dimensionalities, and selecting a primary component to perform K_means clustering analysis according to dimensionality reduction result and selecting several clustering centers as a main flow line of each of flow lines by taking a clustering result of each of flow lines as reference; and
Step 3.4, calculating an average flow field intensity
$$\overline{E} = \frac{{\sum }_{1}^{M} {\sum }_{1}^{N} E}{M * N} ,$$
and an average flow line density
$$\overline{D} = \frac{{\sum }_{1}^{M} {\sum }_{1}^{N} D}{M * N} ,$$
of each of flow lines, wherein M is a total number of flow lines in the group of flow lines and N is a number of the flow line points on each of flow lines; and
Step 3.4, simplifying the flow field, wherein a color of the main flow line represents an average flow field intensity reflecting influence of a historical flow field, coarseness of the main flow line represents an average flow line density of a current flow field region reflecting an instantaneous characteristic of the flow field, thereby realizing visualized characterization of the flow field.

8. The injection-production relationship optimization method based on heterogeneous flow field characterization according to claim 3, characterized in that Step 4 comprises the specific steps of:
Step 4.1, defining a uniformity coefficient of the flow field: defining a displacement capacity of a region between well pairs of each of flow fields as Rᵢⱼ=Ē*D̅, wherein Ē represents an average flow field intensity between the well pairs, D̅ represents an average flow line density between the well pairs, the flow field intensity reflects a historical displacement capacity and the flow line density reflects a current flow field displacement capacity; and defining the flow field displacing uniformity coefficient as U=Var(Rᵢⱼ);
Step 4.2, simulating a flow line numerical value on an initial injection and production amount, and calculating the flow field displacing uniformity coefficient U according to the average flow line intensity and the average flow line density between the flow lines according to Step 1 and Step 2; and
Step 4.3, adopting an improved genetic algorithm to ensure unchanged total injection and production amount to simulate displacement and mutation operations of the nature, wherein an optimized objective function is the minimum flow field displacement nonuniformity coefficient U, and generating a more preferred injection and production scheme by means of an optimization algorithm.

9. The injection-production relationship optimization method based on heterogeneous flow field characterization according to claim 2, characterized in that Step 4 comprises the specific steps of:
Step 4.1, defining a uniformity coefficient of the flow field: defining a displacement capacity of a region between well pairs of each of flow fields as Rᵢⱼ=Ē*D̅, wherein Ē represents an average flow field intensity between the well pairs, D̅ represents an average flow line density between the well pairs, the flow field intensity reflects a historical displacement capacity and the flow line density reflects a current flow field displacement capacity; and defining the flow field displacing uniformity coefficient as U=Var(Rᵢⱼ);
Step 4.2, simulating a flow line numerical value on an initial injection and production amount, and calculating the flow field displacing uniformity coefficient U according to the average flow line intensity and the average flow line density between the flow lines according to Step 1 and Step 2; and
Step 4.3, adopting an improved genetic algorithm to ensure unchanged total injection and production amount to simulate displacement and mutation operations of the nature, wherein an optimized objective function is the minimum flow field displacement nonuniformity coefficient U, and generating a more preferred injection and production scheme by means of an optimization algorithm.
